(19) United States
(12) Patent Application Publication
(10) Pub. No.: US 2012/0312643 A1
(43) Pub. Date: Dec. 13, 2012

(54) Disc Brake

(75) Inventors: Sylvain Derouault, Hemival les Vaux (FR); Stephane Hericher, Basseneville (FR)

(73) Assignee: KNORR-BREMSE Systeme fuer Nutzfahzeuge GmbH, Muenchen (DE)

(21) Appl. No.: 13/528,417

(22) Filed: Jun. 20, 2012

Related U.S. Application Data
(63) Continuation of application No. PCT/EP2010/069744, filed on Dec. 15, 2010.

(30) Foreign Application Priority Data
Dec. 21, 2009 (DE) 10 2009 059 817.0

(51) Int. Cl. B60T 1/06; B60T 11/10

(52) U.S. Cl. 188/72.4

(57) ABSTRACT

A pneumatic disc brake has a brake caliper extending over a brake disc, wherein a brake cylinder, to which compressed air can be applied, and at least one further functional part are fastened on a flange of the brake caliper. The brake cylinder is provided with at least one indentation at least in the overlapping region with the at least one functional part.

### CROSS-REFERENCE TO RELATED APPLICATIONS

This application is a continuation of PCT International Application No. PCT/EP2010/069744, filed Dec. 15, 2010, which claims priority under 35 U.S.C. §119 from German Patent Application No. DE 10 2009 059 817.0, filed Dec. 21, 2009, the entire disclosures of which are herein expressly incorporated by reference.

### BACKGROUND AND SUMMARY OF THE INVENTION

The present invention relates to a pneumatically actuable disc brake having a brake caliper extending around a brake disc, wherein a brake cylinder, which can be subjected to compressed air and has an internal diaphragm and a cylinder plunger coupled to the diaphragm, is fastened, together with at least one further functional part, to a flange of the brake caliper.

A pneumatically actuable disc brake of this type is known, for example, from DE 10 2008 004 896 A1 or DE 10 2006 010 215 B3. In this case, a brake cylinder, which can be subjected to compressed air as the braking force generator, is fastened to a flange of a brake caliper.

Further functional parts in addition to the brake cylinder are often fastened to this flange of the brake caliper, so that the installation space for a brake cylinder to be installed, or the possibility of installing further functional parts, is restricted thereby.

It is the object of the present invention to develop a pneumatically actuable disc brake in such a way that it is optimized with regard to installation space and that the functional parts mounted on the brake caliper are easily accessible.

This object is achieved by a disc brake having a brake caliper extending around a brake disc, wherein a brake cylinder, which can be subjected to compressed air and has an internal diaphragm and a cylinder plunger coupled to the diaphragm, is fastened, together with at least one further functional part, to a flange of the brake caliper. The brake cylinder is provided with at least one indentation at least in a region of overlap with the at least one functional part.

As a result of the configuration according to the invention of the brake cylinder, which is indented at least in the region of overlap with the at least one functional part, brake cylinders of relatively large dimensions can also be mounted on the brake caliper in an optimized manner with regard to installation space.

According to a variant of the invention, the indentation(s) extend(s) into the interior of the brake cylinder, the indentation(s) being formed in such a way that the diaphragm is movable freely, or practically freely, in the operating direction. It is thereby prevented that the indentations restrict the range of movement of the diaphragm to a degree relevant to the flow of force of the cylinder plunger coupled to the diaphragm.

According to a further variant of the invention, a lateral surface of the part of the brake cylinder housing close to the flange of the brake caliper is configured with at least one indented region. The diameter of the brake cylinder can thereby be substantially retained.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic perspective view of a brake cylinder mounted on a brake caliper along with two functional parts;

FIG. 2 is a schematic perspective view of a housing part of the brake cylinder;

FIG. 3 is a top view of the housing part shown in FIG. 2, and

FIG. 4 is a sectional side view of the housing part from FIG. 3.

### DETAILED DESCRIPTION OF THE DRAWINGS

In the following description of the figures, terms such as top, bottom, left, right, in front of, behind, etc., relate only to the exemplary representation and position of the disc brake and of other objects selected in the respective figures. These terms should not be understood restrictively; that is, these relationships may change as a result of different working positions, mirror-symmetrical design or the like.

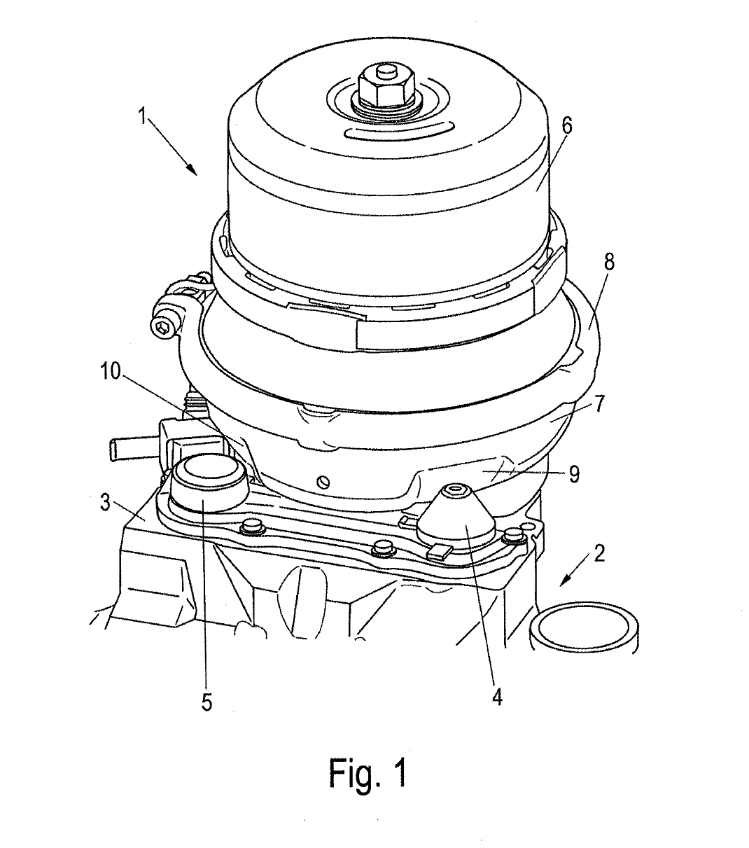

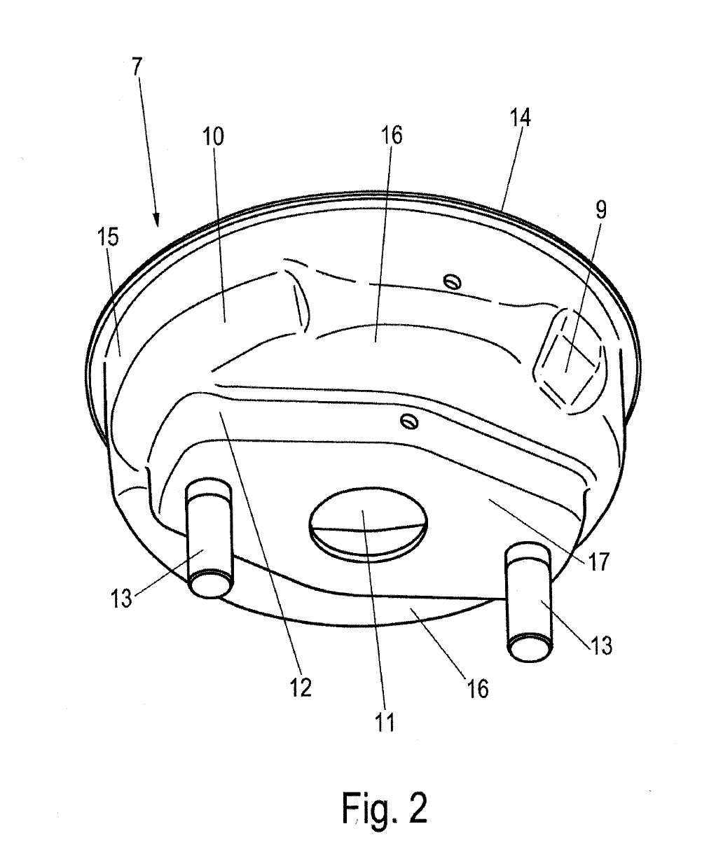

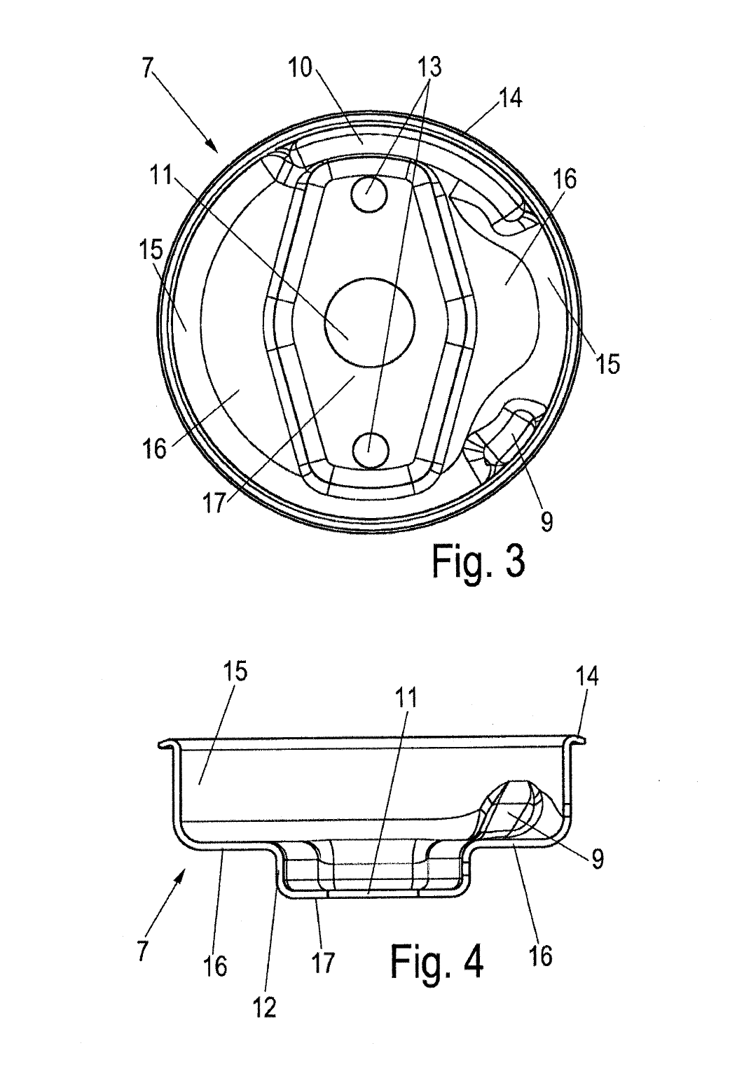

In FIG. 1, a brake cylinder, which is fastened to a flange 3 of a brake caliper 2, is designated as a whole by reference numeral 1. The brake cylinder 1 has a housing, preferably formed in two parts 6, 7. The two housing parts 6, 7 are held together by use of a retaining clamp 8, or by being crimped to one another. The two housing parts 6, 7 have a pot-like configuration, the lateral surfaces of the housing parts 6, 7 each being provided on the edges facing towards one another with a flange 14 (See FIGS. 2-4) around which the retaining clamp 8 can extend.

The brake cylinder 1 is preferably threadably fastened to the flange 3 of the brake caliper 2. Furthermore, at least one further functional part 4, 5, for example in the form of a wear adjuster 4 for a brake application device that subjects a brake pad to pressure, and/or a functional part 5 configured as a connecting piece for a wear indicating display, is/are arranged on the flange 3 of the brake caliper 2, in addition to the brake cylinder 1.

In order to be able to make optimum use of the available area on the flange 3 of the brake caliper 2, the brake cylinder 1 must be positioned very close to the functional parts 4, 5. For this purpose, the brake cylinder 1 is configured with at least one indentation 9, 10, so that the brake cylinder 1 and the functional part(s) 4, 5 partially overlap, although, through the configuration of the indentations 9, 10 of the brake cylinder housing, the functional parts 4, 5 are nevertheless optimally accessible. In addition, through such a shaping of the brake cylinder housing, a reduction in the diameter of the brake cylinder 1, and therefore a reduction in the maximum force acting on a cylinder plunger axially displaceable in the brake cylinder 1, can be avoided. In this case, the cylinder plunger acts on a pivoted brake lever (not shown) which is preferably mounted eccentrically on the brake caliper 2 and is swiveled by an axial movement of the cylinder plunger upon actuation of the brake.

In this case, the indentations extend into the interior of the brake cylinder 1, but not, or only slightly, into the range of movement of the diaphragm. What is important is that the indentations restrict the range of movement of the diaphragm only to a degree which is not relevant to the flow of force of the cylinder plunger coupled to the diaphragm.

As shown in FIGS. 2 to 4, in the multi-part brake cylinder housing shown here, the housing part 7 of the brake cylinder 1 located close to the flange 3 of the brake caliper 2 is configured with two indentations 9, 10. These indented areas are located, in particular, in the region of a rounded edge between a base 16 of the housing part 7 and a cylindrical lateral surface 15 of this housing part 7, and are preferably positioned parallel to the rounded edge of the housing part 7.

In order to fasten the brake cylinder 1, an elevated portion 12 rises from the base 16 of the housing part 7 of the brake cylinder 1 close to the flange 3 of the brake caliper 2, from which elevated portion 12 two sleeves 13, which are formed integrally thereon, extend perpendicularly, projecting into bores (not shown) in the flange 3 of the brake caliper 2 and serving as guides for screws for securing the brake cylinder housing 6, 7 to the brake caliper 2. In addition, this elevated portion 12 is provided with a central bore 11 for the axially displaceable cylinder plunger.

The indentations 9, 10 are preferably configured as flattened portions, although a concave configuration on the outside is also possible, depending on the configuration of the functional part 4, 5, as close as possible to which the brake cylinder 1 is to be mounted. In the case when a plurality of indented regions are formed, the indentations 9, 10 are preferably spaced apart from one another in order substantially to retain the cylindrical configuration of the cylinder housing while nevertheless achieving a compact structure of the disc brake.

The indentations 9, 10 are preferably formed by stamping the housing part 7, although other reshaping processes are also possible.

### LIST OF REFERENCE NUMERALS

Brake cylinder 1
Brake caliper 2
Flange 3
Functional part 4
Functional part 5
Housing 6
Housing 7
Retaining clamp 8
Indentation 9
Indentation 10
Bore 11
Elevated portion 12
Sleeves 13
Flange 14
Lateral surface 15
Base 16
Base of elevated portion 17

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is;

1. A pneumatic disc brake for use with a brake disc, comprising:
a caliper operatively configurable to straddle the brake disc;
a brake cylinder having an internal diaphragm and a cylinder plunger coupled to the diaphragm, the brake cylinder being fastened to a flange of the brake caliper; and
at least one additional functional part fastened to the flange of the brake caliper;
wherein a housing of the brake cylinder comprises at least one indentation, the at least one indentation being located at least in an overlapping region with the at least one additional functional part.

2. The disc brake according to claim 1, wherein the at least one indentation extends into an interior of the brake cylinder, the indentation being configured such that the diaphragm is substantially freely movable in an operating direction.

3. The disc brake according to claim 1, wherein the at least one indentation is formed in a lateral surface of the housing of the brake cylinder located near the flange of the caliper.

4. The disc brake according to claim 2, wherein the at least one indentation is formed in a lateral surface of the housing of the brake cylinder located near the flange of the caliper.

5. The disc brake according to claim 1, wherein the housing of the brake cylinder comprises a two-part housing.

6. The disc brake according to claim 3, wherein the brake cylinder comprises an elevated portion having a central bore for allowing axial displacement of the cylinder plunger, the elevated portion extending from a base of the housing near the flange of the caliper; and
wherein a rounded edge between the base and a cylindrical lateral surface of the housing oriented away from a pressure side is configured with the at least one indentation.

7. The disc brake according to claim 5, wherein the brake cylinder comprises an elevated portion having a central bore for allowing axial displacement of the cylinder plunger, the elevated portion extending from a base of the housing near the flange of the caliper; and
wherein a rounded edge between the base and a cylindrical lateral surface of the housing oriented away from a pressure side is configured with the at least one indentation.

8. The disc brake according to claim 6, wherein the at least one indentation in the housing is configured such that a volume of the brake cylinder is above a threshold value at which a force exertable on the cylinder plunger does not fall below a minimum value.

9. The disc brake according to claim 7, wherein the at least one indentation in the housing is configured such that a volume of the brake cylinder is above a threshold value at which a force exertable on the cylinder plunger does not fall below a minimum value.

10. The disc brake according to claim 1, wherein the at least one indentation has a flattened configuration.

11. The disc brake according to claim 1, wherein the at least one indentation has a concave shape viewed from outside the brake cylinder.

12. The disc brake according to claim 1, wherein the brake cylinder comprises two indentations spaced apart from one another.

13. The disc brake according to claim 1, wherein the at least one indentation is a stamped indentation in the housing.
